(19) United States
(12) Patent Application Publication
(10) Pub. No.: US 2019/0354606 A1
(43) Pub. Date: Nov. 21, 2019

(54) Private Cryptocoinage in Blockchain Environments

(71) Applicant: Factom, Austin, TX (US)

(72) Inventor: Paul Snow, Austin, TX (US)

(21) Appl. No.: 15/983,572

(22) Filed: May 18, 2018

(51) Int. Cl. G06F 17/30; H04L 9/06; H04L 9/08; G06Q 20/38

(52) U.S. Cl. CPC G06F 17/30185; H04L 9/0643; H04L 9/0861; H04L 2209/38; G06Q 20/382; H04L 2209/56; G06F 17/30283

(57) ABSTRACT

Cryptocoinage is established in a blockchain environment. Any entity (whether public or private) may issue its own cryptocoinage for public recordation to a blockchain data layer. The blockchain data layer generates data records representing transaction records of the cryptocoinage. The blockchain data layer may also hash the transaction records to generate a cryptographic proof for public disclosure via a public blockchain. Moreover, the cryptographic proof may be anchored to another public blockchain representing a different cryptocoinage (such as BITCOIN®). The blockchain data layer may be searched for the data records representing the transaction records of the cryptocoinage.

### CROSS-REFERENCE TO RELATED APPLICATIONS

This application relates to U.S. application Ser. No. ______ filed May 18, 2018, entitled “Load Balancing in Blockchain Environments” (Attorney Docket Factom #11), and incorporated herein by reference in its entirety. This application also relates to U.S. application Ser. No. ______ filed May 18, 2018, entitled “Import and Export in Blockchain Environments” (Attorney Docket Factom #12), and incorporated herein by reference in its entirety. This application also relates to U.S. application Ser. No. ______ filed May 18, 2018, entitled “Personal Blockchain Services” (Attorney Docket Factom #13), and incorporated herein by reference in its entirety. This application also relates to U.S. application Ser. No. ______ filed May 18, 2018, entitled “Private Blockchain Services” (Attorney Docket Factom #14), and incorporated herein by reference in its entirety.

### BACKGROUND

Decentralized cryptographic coinage is growing. As cryptographic coinage continues to gain acceptance, many entities will want to offer their own cryptographic coinage.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIGS. 1-8 are simplified illustrations of entity-based cryptographic coinage, according to exemplary embodiments;

FIGS. 9-11 are detailed illustrations of an operating environment, according to exemplary embodiments;

FIGS. 12-16 illustrate a blockchain data layer, according to exemplary embodiments;

FIGS. 17-19 illustrate a single cryptographic address, according to exemplary embodiments;

FIGS. 20-22 illustrate a filling station, according to exemplary embodiments;

FIG. 23 illustrates a public entity, according to exemplary embodiments;

FIG. 24 is a flowchart illustrating a method or algorithm for the private, entity based cryptocoinage, according to exemplary embodiments; and

FIGS. 25-26 depict still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

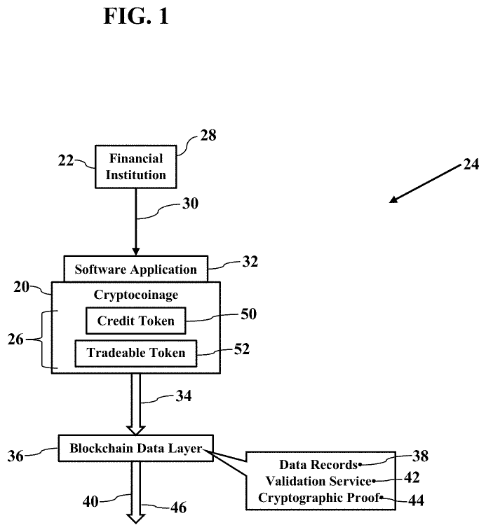

FIGS. 1-8 are simplified illustrations of entity-based cryptographic coinage 20, according to exemplary embodiments. Here any entity 22 may create its own cryptographic coinage 20 in a blockchain environment 24. The entity 22, in other words, may establish entity-specific electronic tokens 26 to access and/or to use the blockchain environment 24. While exemplary embodiments may be applied to any entity 22, most readers are thought familiar with financial services. That is, suppose the entity 22 is a bank, lender, or other financial institution 28 (such as PIMCO®, CITI®, or BANK OF AMERICA®). As the reader likely understands, the financial institution 28 creates a massive amount of banking records, transaction records, mortgage instruments, and other private data 30. The financial institution 28 thus has a software application 32 that encrypts its private data 30. While the financial institution 28 may use any encryption scheme, FIG. 1 illustrates a private blockchain 34. That is, the financial institution 28 cryptographically hashes the private data 30 into the private blockchain 34 and sends or feeds the private blockchain 34 to a blockchain data layer 36. The blockchain data layer 36 generates various data records 38, as later paragraphs will explain. Moreover, the blockchain data layer 36 may also add another layer of cryptographic hashing to generate a public blockchain 40. The blockchain data layer 36 acts as a validation service 42 and generates a cryptographic proof 44. The public blockchain 40 thus publishes the cryptographic proof 44 as a public ledger 46 that establishes chains of blocks of immutable evidence.

The entity-specific tokens 26 are associated with the entity 22. The financial institution 28, for example, generates and/or issues the entity-specific tokens 26 to access the private blockchain 34. Because the private blockchain 34 represents hashes of the financial institution's private data 30, the private blockchain 34 may be considered a private resource or property of the financial institution 28. That is, the private blockchain 34 is controlled by, or affiliated with, the financial institution 28, so the financial institution 28 may control who adds and/or writes to the private blockchain 34 and who reads, accesses, or receives the private blockchain 34.

The entity-specific tokens 26 may thus be control mechanisms. While the entity-specific tokens 26 may have any functional scheme, FIG. 1 illustrates a private credit token 50 and a private tradeable token 52. The entity's credit token 50, for example, may be acquired and then spent or burned when accessing the financial institution's private blockchain 34. The entity's credit token 50, in other words, represents any credit-based entry system associated with the financial institution's private blockchain 34. The tradeable token 52, on the other hand, may be generated for transfer among others. The entity 22 generates the tradeable token 52 to be traded and/or spent. The tradeable token 52, in other words, may be considered as the entity's specific, private currency to be used as the entity 22 governs.

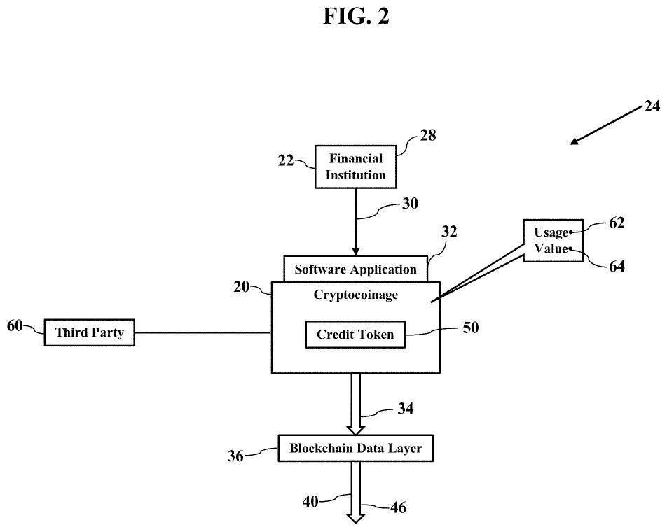

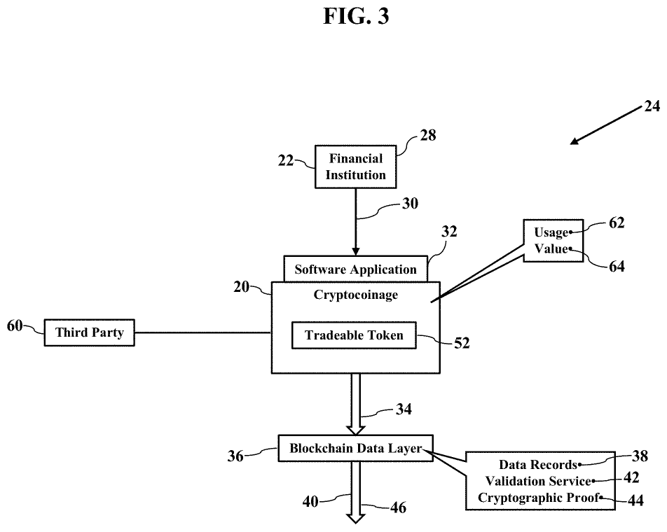

FIGS. 2-3 illustrate examples of the entity-specific tokens 26. Suppose that a third-party 60 wishes to receive, read, write to, or otherwise access the financial institution's private blockchain 34. As FIG. 2 illustrates, exemplary embodiments may require that the third-party 60 spend or burn one or more of the credit tokens 50. The credit token 50 may thus control access to the financial institution's private blockchain 34. The inventor envisions that vendors, service providers, individual users, and other third-parties 60 may wish to access the hash values of the private data 30 contained within the financial institution's private blockchain 34. The financial institution 28 may thus require that the third-party 60 redeem the entity's credit token(s) 50 before granting read, write, or access permission. The financial institution 28 may additionally or alternatively require redemption of the entity's credit token(s) 50 for using protocols, rules, and application programming interfaces (“APIs”) associated with the private blockchain 34. The financial institution 28 may thus establish or issue its own credit tokens 50 and even govern their usage restrictions 62 and value 64, as later paragraphs will explain.

FIG. 3 illustrates the tradeable token 52. The financial institution 28 may establish the tradeable token 52 and also govern its usage restrictions 62 and value 64. The tradeable token 52, in other words, is a cryptocurrency or “coin.” Again, while exemplary embodiments may utilize any functional scheme, the tradeable token 52 may be earned. That is, anyone (such as the third party 60) may earn the tradeable token 52 according to the usage restrictions 62. For example, suppose the blockchain data layer 36 earns the entity's tradeable token(s) 52 in exchange for the validation service 42. That is, a provider of the validation service 42 is paid, or earns, the entity's tradeable token(s) 52 for cryptographically hashing the proof 44. The provider of the validation service 42 may also be paid in the entity's tradeable token(s) 52 for publishing the proof 44. The tradeable token 52 may thus be transferred as currency according to the usage restrictions 62 and its value 64.

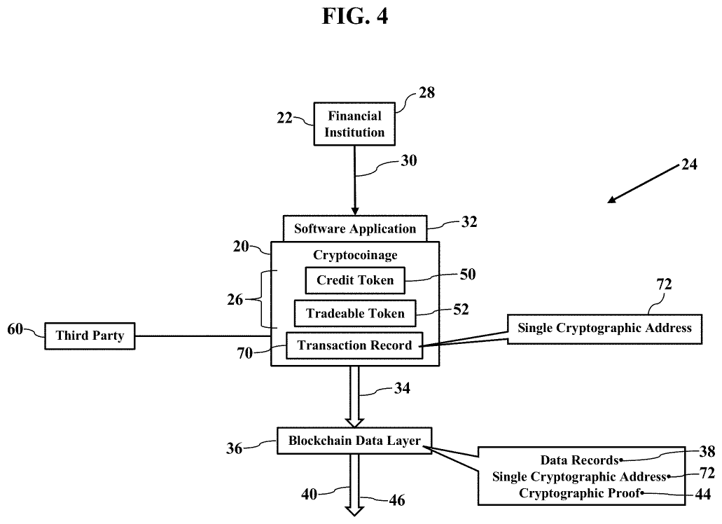

FIG. 4 illustrates transaction records 70. Whenever the entity-specific tokens 26 are created, owned, or transferred, the transaction record 70 may be generated. The transaction record 70 may then be documented in the blockchain environment 24. For example, the entity-specific tokens 26 may be addressable. That is, the credit token 50 and the tradeable token 52 may be uniquely associated with a common, single cryptographic address 72. The cryptographic address 72 may represent an owner or holder (e.g., the entity 22 or the third-party 60). When the entity-specific tokens 26 are created, generated, or assigned, the entity-specific tokens 26 may be assigned or associated with the cryptographic address 72. The cryptographic address 72 may then be received by, and propagated within, the blockchain data layer 36 to identify the corresponding data records 38. The blockchain data layer 36 may even hash the cryptographic address 72 as the cryptographic proof 44 of the transaction records 70. Exemplary embodiments thus publically document the transaction records 70 involving the entity-specific tokens 26, based on the single cryptographic address 72. In simple words, the blockchain data layer 36 publishes ownership and transfer proofs 44 of the credit token 50 and the tradeable token 52 based on the transaction records 70 associated with the single cryptographic address 72.

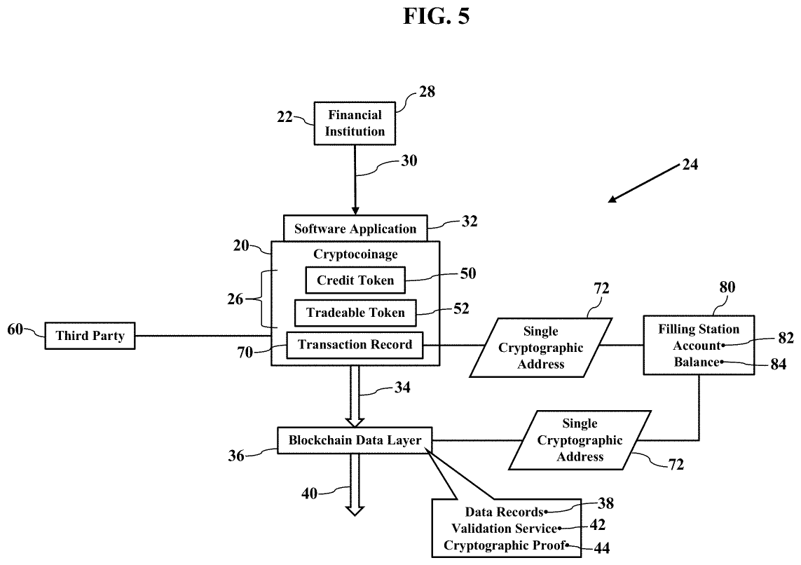

FIG. 5 illustrates a filling station 80 in the blockchain environment 24. Because the entity's credit tokens 26 may be consumed by users (such as the third-party entity 22), the filling station 80 allows the third party 60 to replenish or fill an account 82. Recall that the third-party entity 22 may be required to spend the credit tokens 26 to access the financial institution's private blockchain 34. The third-party entity 22 may thus establish the account 82 and maintain a monetary or numerical balance 84 of the entity's credit tokens 26. As the third-party entity 22 redeems the credit tokens 26, the account 82 may need filling to continue using or accessing the financial institution's private blockchain 34.

The filling station 80 may access both the entity's transaction records 70 and the blockchain data layer 36. Because the blockchain data layer 36 may document the data records 38 using the single cryptographic address 72, the single cryptographic address 72 may serve as a common reference or query parameter with the entity's transaction records 70. The filling station 80, in other words, may use the single cryptographic address 72 to identify the transaction records 70 that correspond to the blockchain data layer 36. The filling station 80 may thus present a transaction summary of the account 82 and the balance 84. Because blockchain data layer 36 may track and/or prove the transaction records 70, exemplary embodiments may search the blockchain data layer 36 for the single cryptographic address 72. That is, the filling station 80 may query the blockchain data layer 36 for the single cryptographic address 72, and the blockchain data layer 36 may identify the transaction records 70 that match the single cryptographic address 72. The filling station 80 may then process the transaction records 70 to provide the transaction summary of the account 82, the balance 84, and any other transactional data. The filling station 80 may also allow the user to replenish an amount or value of the credit tokens 26, thus allowing the user to continue exchanging the credit tokens 26 for access to the private blockchain 34 and/or the blockchain data layer 36.

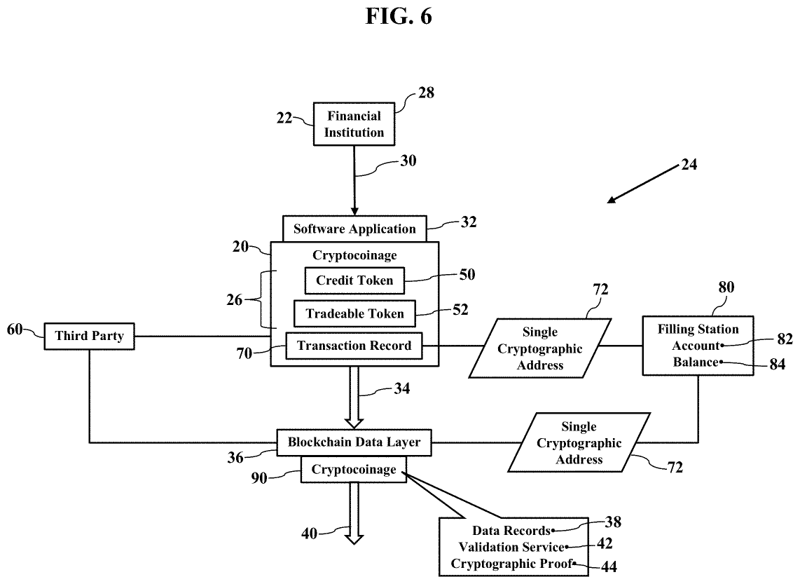

FIG. 6 further illustrates the filling station 80. Here the blockchain data layer 36 may have its own cryptocoinage 90. That is, a provider of the blockchain data layer 36 may establish its cryptocoinage 90 for accessing and/or using the validation service 42. The cryptocoinage 90 may thus include a credit token and a tradeable token (not shown for simplicity). The credit token may be required to enter or access the blockchain data layer 36 to receive the validation service 42, and the tradeable token may be earned for participating in the validation service 42. Regardless, the filling station 80 may use the single cryptographic address 72. The third party 60 may use the single cryptographic address 72 to access the entity's cryptocoinage 20 and the blockchain data layer's cryptocoinage 90. Exemplary embodiments may thus identify and track the transaction records 70 and the blockchain data layer's cryptocoinage 90 using the same, single cryptographic address 72.

Exemplary embodiments thus present an elegant solution. Any entity 22 may create its own private blockchain 34. The entity 22 may then establish or create entity-specific tokens 26 for using, accessing, or processing the entity's private blockchain 34. The entity-specific tokens 26 may have the value 64, thus fostering a market for entity-specific tradeable assets in the blockchain environment 24. Exemplary embodiments may thus provide a two-token system that isolates any use of the entity's private blockchain 34 from the entity's tradeable token 52. Moreover, the credit token 50 may be associated with the third party 60 (perhaps via the single cryptographic address 72), thus allowing the third party 60 to retrieve the account balance 84 from the filling station 80 and sign entries or other transactions. Moreover, the third party 60 may also use the single cryptographic address 72 to access the blockchain data layer 36 via the filling station 80. The filling station 80 is a single resource or destination (such as a secure website) for managing a user's cryptographic coinage 20.

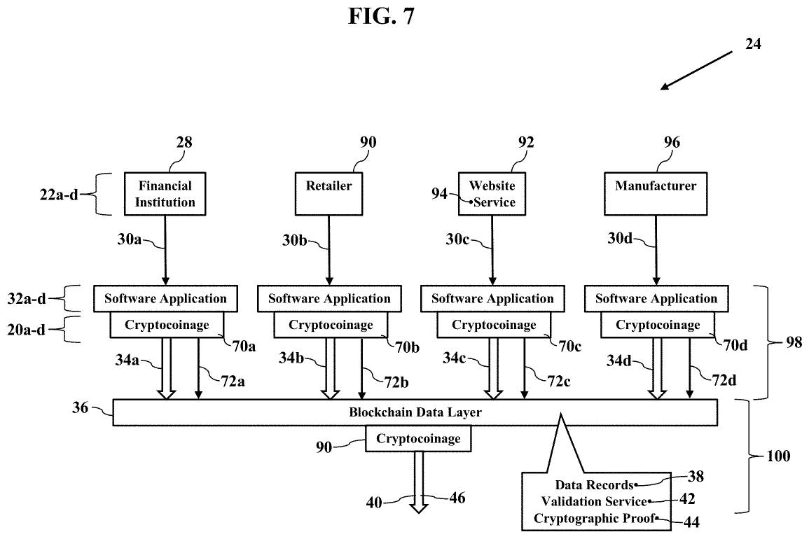

FIG. 7 expands the entity concept. Here multiple, different entities 22a-d provide their respective software applications 32a-d that encrypt their respective private data 30a-d as their individual, private blockchains 34a-d. While exemplary embodiments may be applied to any number of industries or services, FIG. 7 illustrates a simple example of four (4) different entities 22a-d. First entity 22a, for example, again represents the bank, lender, or other financial institution 28 that encrypts its private data 30a as its private blockchain 34a. Second entity 22b represents any retailer 90 (such as HOME DEPOT®, KOHL'S®, or WALMART®) that encrypts its private data 30b as its private blockchain 34b. Third entity 22c represents a website 92 offering a service 94 (such as AMAZON®, NETFLIX®, or GOOGLE®) that encrypts its private data 30c as the private blockchain 34c. Fourth entity 22d represents an automotive or other manufacturer or supplier 96 (such as FORD®, TOYOTA®, or DELPHI®) that encrypts its private data 30d as the private blockchain 34d. The entities 22a-d thus use their respective software applications 32a-d to provide a first layer 98 of cryptographic hashing. The entities 22a-d may also use their respective software applications 32a-d to issue their own private and entity-specific cryptocoinage 20a-d. Each entity 22a-d may then send their respective private blockchains 34a-d to the blockchain data layer 36, and the blockchain data layer 36 may add a second layer 100 of cryptographic hashing. The blockchain data layer 36 thus generates the public blockchain 40 as a public resource or utility for record keeping. Any entity 22 that subscribes to the blockchain data layer 36 (such as by acquiring and/or spending the cryptocoinage 90. Any entity 22 may thus write and store the proofs 44 of its private data 30 to the public blockchain 40. The blockchain data layer 36, in other words, acts as the public ledger 46 that establishes chain of blocks of immutable evidence.

As FIG. 7 also illustrates, each entity 22a-d may establish its own private cryptocoinage 20a-d. Each entity's private software application 32a-d may create and/or issue its cryptocoinage 20a-d (such as respective entity-specific tokens 26 above explained). Each entity 22a-d may also establish its own usage restrictions and value (illustrated as reference numerals 62 and 64 in FIGS. 2-3) according to rules governing ownership, trade, and other policies. Each entity 22a-d may generate and sends its respective transaction records 70a-d which reference each entity's single cryptographic address 72a-d) to the blockchain data layer 36 for documentation.

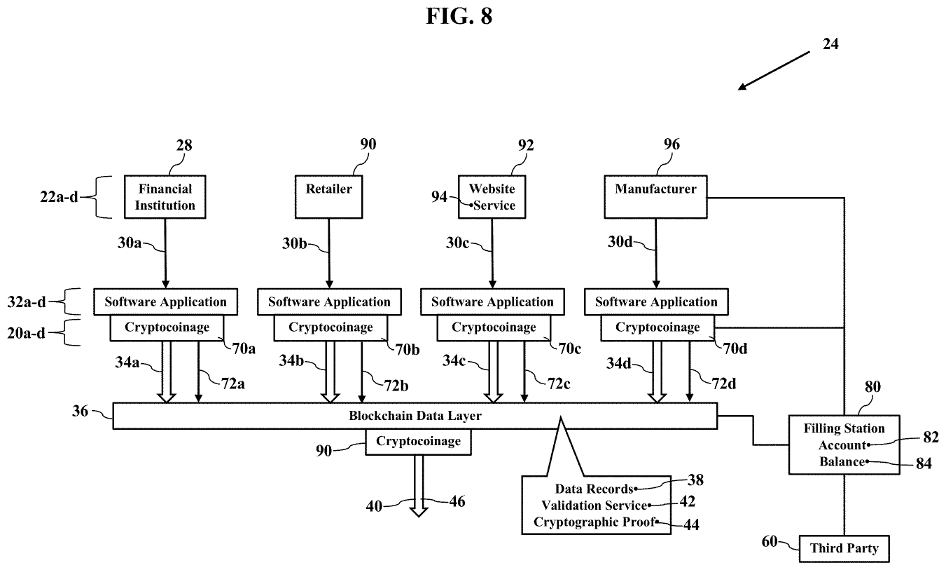

As FIG. 8 illustrates, the filling station 80 is agnostic. Any user (such as the entity 22a-d or the third party 60) may authenticate to the filling station 80. Once authenticated, the user need only enter or provide the correct single cryptographic address 72a-d to access both the entity's private cryptocoinage 20a-d and the blockchain data layer's cryptocoinage 90. The single cryptographic address 72a-d, in other words, allows the user to access her account 82 and balance 84 for both entity's private cryptocoinage 20a-d and the blockchain data layer's cryptocoinage 90. The user may thus easily conduct transactions between the entity's private cryptocoinage 20a-d and the blockchain data layer's cryptocoinage 90. The entity 22a-d, for example, may fuel or replenish its supply of the blockchain data layer's cryptocoinage 90, perhaps by redeeming or exchanging the entity's private cryptocoinage 20a-d (perhaps according to an exchange rate or other value). Similarly, the provider of the blockchain data layer 36 may fuel or replenish its supply of the entity's private cryptocoinage 20a-d by purchasing or exchanging the blockchain data layer's cryptocoinage 90. The single cryptographic address 72a-d, associated with both the entity's private cryptocoinage 20a-d and the blockchain data layer's cryptocoinage 90, allows quick and easy transactions. Moreover, both the respective private blockchains 34a-d and the blockchain data layer 36 would contain the data records 38 confirming these transactions, so the transaction records 70a-d thus propagate into the blockchain data layer 36 for public disclosure via the public blockchain 40. Any user that successfully authenticates to the filling station 80 may access a full accounting of his or her digital cryptocoinages 20a-d and/or 90 according to the respective single cryptographic address 72a-d. The user may thus buy, sell, trade, and/or redeem any entity-specific cryptocoinages 20a-d and/or 90, all by accessing the filling station 80. The user may buy or sell any entity's coins or replenish credits, all by accessing the filling station 80.

Exemplary embodiments thus present another elegant solution. The filling station 80 is another service offered by the blockchain data layer 36. Because all the transaction records 70 in the blockchain data layer 36 are identifiable (perhaps via the single cryptographic address 72), the filling station 80 can present the summary of the user's credit tokens and tradeable tokens. The filling station 80 may thus provide a single or universal electronic wallet for all of a user's digital coinage and credits, regardless of the issuing entity 22a-d. The user may thus only perform a single authentication to the blockchain data layer 36 and access all her cryptofunds.

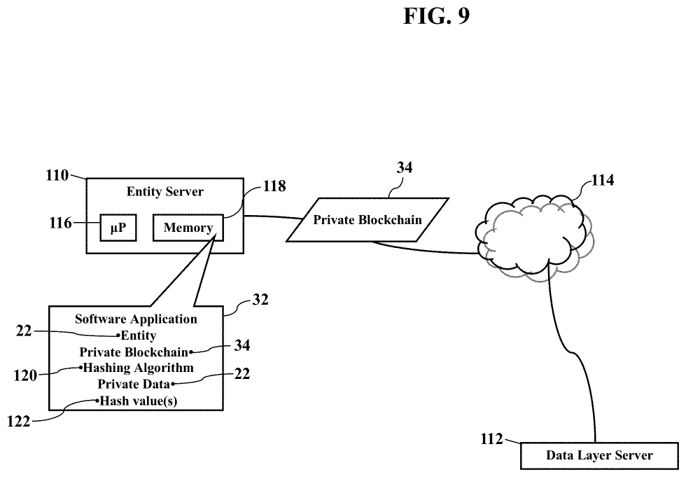

FIGS. 9-11 are more detailed illustrations of an operating environment, according to exemplary embodiments. FIG. 9 illustrates an entity server 110 communicating with a data layer server 112 via a communications network 114. The entity server 110 operates on behalf of the entity 22 and generates the entity's private blockchain 34. The entity server 110, in other words, has a processor 116 (e.g., “μP”), application specific integrated circuit (ASIC), or other component that executes the entity's software application 32 stored in a local memory device 118. The entity server 110 has a network interface to the communications network 114, thus allowing two-way, bidirectional communication with the data layer server 112. The entity's software application 32 includes instructions, code, and/or programs that cause the entity server 110 to perform operations, such as calling, invoking, and/or applying an electronic representation of a hashing algorithm 120 to the entity's private data 30. The hashing algorithm 120 thus generates one or more hash values 122, which are incorporated into the entity's private blockchain 34. The entity's software application 32 then instructs the entity server 110 to send the private blockchain 34 via the communications network 114 to a network address (e.g., Internet protocol address) associated with the data layer server 112.

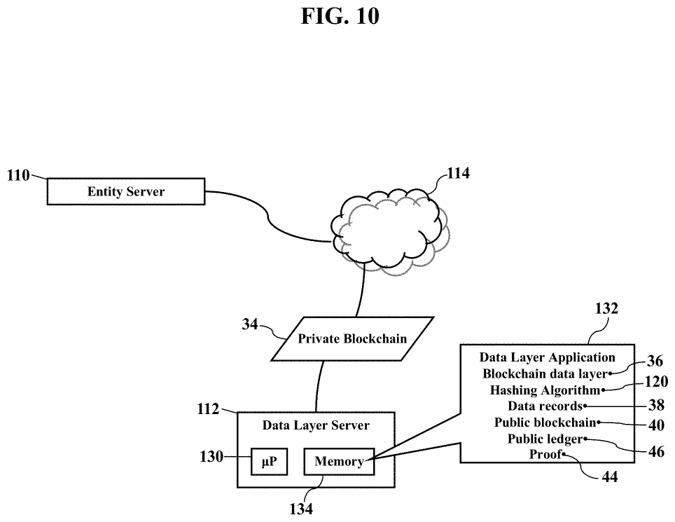

FIG. 10 illustrates the blockchain data layer 36. The data layer server 112 has a processor 130 (e.g., “μP”), application specific integrated circuit (ASIC), or other component that executes a data layer application 132 stored in a local memory device 134. The data layer server 112 has a network interface to the communications network 114. The data layer application 132 includes instructions, code, and/or programs that cause the data layer server 112 to perform operations, such as receiving the entity's private blockchain 34. The data layer application 132 then causes the data layer server 112 to generate the blockchain data layer 36. The data layer application 132 may optionally call, invoke, and/or apply the hashing algorithm 120 to the data records 38 contained within the blockchain data layer 36. The data layer application 132 may also generate the public blockchain 40. The data layer application 132 may thus generate the public ledger 46 that publishes, records, or documents the cryptographic proof 44 of the blocks of data contained within the private blockchain 34.

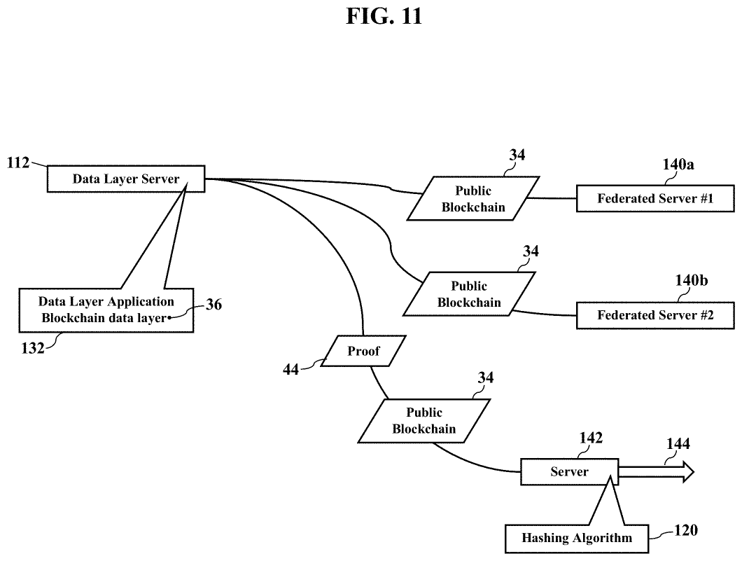

FIG. 11 illustrates additional publication mechanisms. Once the blockchain data layer 36 is generated, the blockchain data layer 36 may be published in a decentralized manner to any destination. The data layer server 112, for example, may generate and distribute the public blockchain 40 (via the communications network 114 illustrated in FIGS. 9-10) to one or more federated servers 140. While there may be many federated servers 140, for simplicity FIG. 11 only illustrates two (2) federated servers 140a and 140b. The federated servers 140a and 140b provide a service and, in return, they are compensated according to a compensation or services agreement or scheme.

Exemplary embodiments include still more publication mechanisms. For example, the cryptographic proof 44 and/or the public blockchain 40 may be sent (via the communications network 114 illustrated in FIGS. 9-10) to a server 142. The server 142 may then add another, third layer of cryptographic hashing (perhaps using the hashing algorithm 120) and generate another or second public blockchain 144. While the server 142 and/or the public blockchain 144 may be operated by, or generated for, any entity, exemplary embodiments may integrate another cryptographic coin mechanism. That is, the server 142 and/or the public blockchain 144 may be associated with BITCOIN®, ETHEREUM®, RIPPLE®, or other cryptographic coin mechanism. The cryptographic proof 44 and/or the public blockchain 40 may be publically distributed and/or documented as evidentiary validation. The cryptographic proof 44 and/or the public blockchain 40 may thus be historically and publically anchored for public inspection and review.

Exemplary embodiments may be applied regardless of networking environment. Exemplary embodiments may be easily adapted to stationary or mobile devices having cellular, wireless fidelity (WI-FI®), near field, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform “operations,” this could include the processor performing the operations directly and/or facilitating, directing, or cooperating with another device or component to perform the operations.

Exemplary embodiments may packetize. When the entity server 110 and the data layer server 112 communicate via the communications network 114, the entity server 110 and the data layer server 112 may collect, send, and retrieve information. The information may be formatted or generated as packets of data according to a packet protocol (such as the Internet Protocol). The packets of data contain bits or bytes of data describing the contents, or payload, of a message. A header of each packet of data may contain routing information identifying an origination address and/or a destination address.

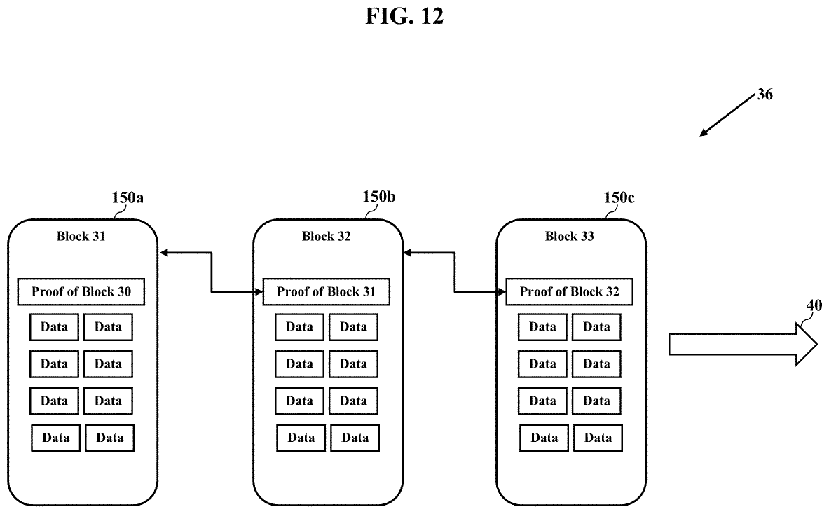

FIGS. 12-16 further illustrate the blockchain data layer 36, according to exemplary embodiments. The blockchain data layer 36 chains hashed directory blocks 150 of data into the public blockchain 40. For example, the blockchain data layer 36 accepts input data (such as the entity's private blockchain 34 illustrated in FIGS. 1-10) within a window of time. While the window of time may be configurable from fractions of seconds to hours, exemplary embodiments use ten (10) minute intervals. FIG. 12 illustrates a simple example of only three (3) directory blocks 150a-c of data, but in practice there may be millions or billions of different blocks. Each directory block 150 of data is linked to the preceding blocks in front and the following or trailing blocks behind. The links are created by hashing all the data within a single directory block 150 and then publishing that hash value within the next directory block.

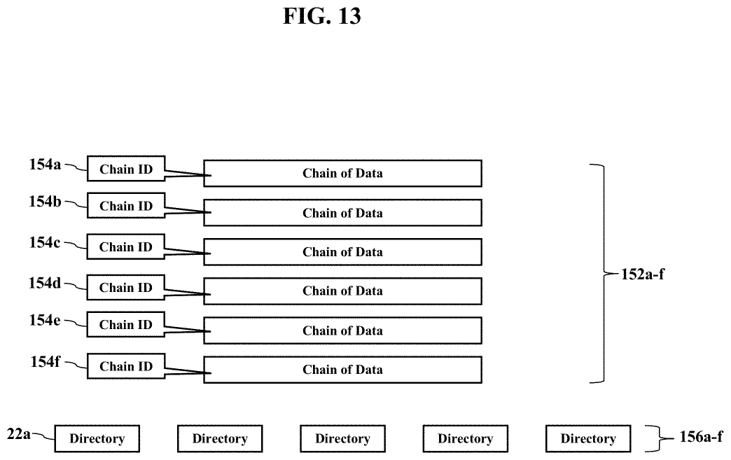

As FIG. 13 illustrates, published data may be organized within chains 152. Each chain 152 is created with an entry that associates a corresponding chain identifier 154. Each entity 22a-f, in other words, may have its corresponding chain identifier 154a-d. The blockchain data layer 36 may thus track any data associated with the entity 22a-f with its corresponding chain identifier 154a-d. New and old data in time may be associated with, linked to, identified by, and/or retrieved using the chain identifier 154a-d. Each chain identifier 154a-d thus functionally resembles a directory 156a-d (e.g., files and folders) for organized data entries according to the entity 22a-f

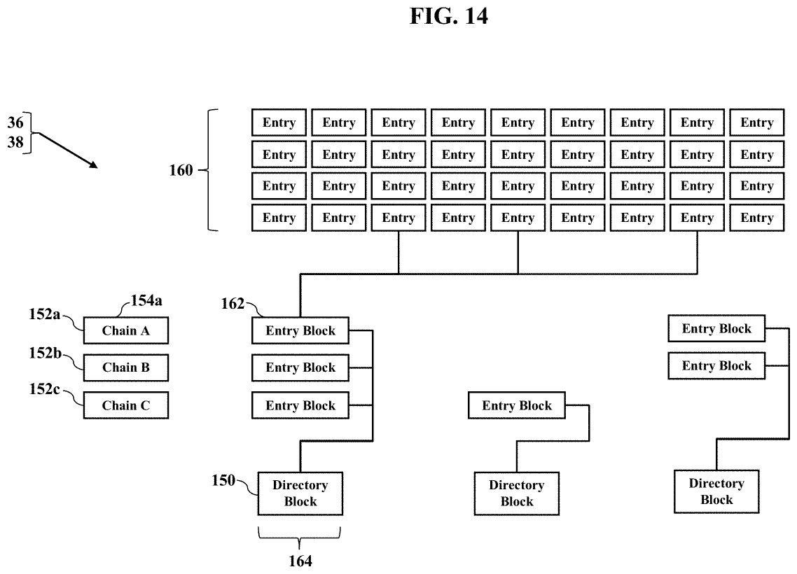

FIG. 14 illustrates the data records 38 in the blockchain data layer 36. As data is received as an input (such as the private blockchain 34 illustrated in FIGS. 1-10), data is recorded within the blockchain data layer 36 as an entry 160. While the data may have any size, small chunks (such as 10 KB) may be pieced together to create larger file sizes. One or more of the entries 160 may be arranged into entry blocks 162 representing each chain 152 according to the corresponding chain identifier 154. New entries for each chain 152 are added to their respective entry block 162 (again perhaps according to the corresponding chain identifier 154). After the entries 160 have been made within the proper entry blocks 162, all the entry blocks 162 are then placed within in the directory block 150 generated within or occurring within a window 164 of time. While the window 164 of time may be chosen within any range from seconds to hours, exemplary embodiments may use ten (10) minute intervals. That is, all the entry blocks 162 generated every ten minutes are placed within in the directory block 150.

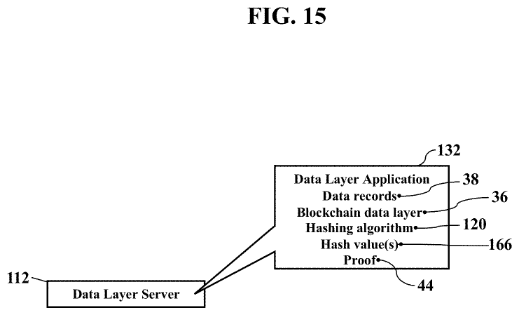

FIG. 15 illustrates cryptographic hashing. The data layer server 112 executes the data layer application 132 to generate the data records 38 in the blockchain data layer 36. The data layer application 132 may then instruct the data layer server 112 to execute the hashing algorithm 120 on the data records 38 (such as the directory block 150 illustrated in FIGS. 12 & 14). The hashing algorithm 120 thus generates one or more hash values 166 as a result, and the hash values 166 represent the hashed data records 38. As one example, the blockchain data layer 36 may apply a Merkle tree analysis to generate a Merkle root (representing a Merkle proof 44) representing each directory block 150. The blockchain data layer 36 may then publish the Merkle proof 44 (as this disclosure explains).

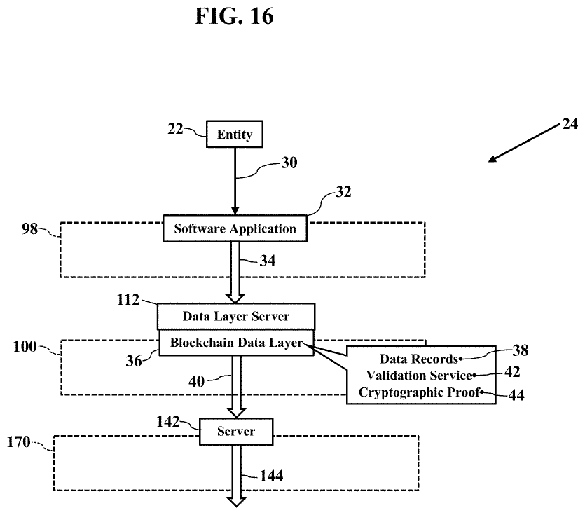

FIG. 16 illustrates hierarchical hashing. The entity's private software application 32 provides the first layer 98 of cryptographic hashing and generates the private blockchain 34. The entity 22 then sends its private blockchain 34 to the data layer server 112. The data layer server 112, executing the data layer application 132, generates the blockchain data layer 36. The data layer application 132 may optionally provide the second or intermediate layer 100 of cryptographic hashing to generate the cryptographic proof 44. The data layer application 132 may also publish any of the data records 38 as the public blockchain 40, and the cryptographic proof 44 may or may not also be published via the public blockchain 40. The public blockchain 40 and/or the cryptographic proof 44 may be optionally sent to the server 142 as an input to yet another public blockchain 144 (again, such as BITCOIN®, ETHEREUM®, or RIPPLE®) for a third layer 170 of cryptographic hashing and public publication. The first layer 98 and the second layer 100 thus ride or sit atop a conventional public blockchain 144 (again, such as BITCOIN®, ETHEREUM®, or RIPPLE®) and provide additional public and/or private cryptographic proofs 44.

Exemplary embodiments may use any hashing function. Many readers may be familiar with the SHA-256 hashing algorithm. The SHA-256 hashing algorithm acts on any electronic data or information to generate a 256-bit hash value 64 as a cryptographic key. The key is thus a unique digital signature. There are many hashing algorithms, though, and exemplary embodiments may be adapted to any hashing algorithm.

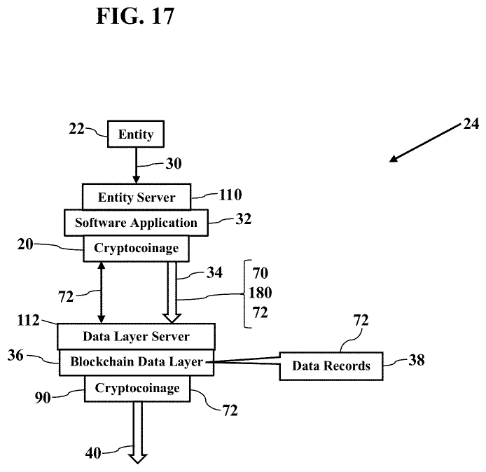

FIGS. 17-19 are more detailed illustrations of the single cryptographic address 72, according to exemplary embodiments. The private entity 22 sends its private blockchain 34 to the network address associated with the data layer server 112 that generates the blockchain data layer 36. The private blockchain 34 may contain information representing the transaction records 70 associated with the entity's private cryptocoinage 20 (perhaps as one or more privately hashed blocks 180 of data). The private blockchain 34 may also specify, or incorporate, information or data representing the single cryptographic address 72. The single cryptographic address 72 may additionally or alternatively be separately sent from the entity server 110 to the data layer server 112. Regardless, the entity's private cryptocoinage 20 may be associated with the single cryptographic address 72. The transaction records 70 and/or the privately hashed blocks 180 of data may thus specify, include, reference, and/or be associated with, and/or identified by, the single cryptographic address 72. Because the single cryptographic address 72 (and/or its corresponding hah value) is an identifiable input to the data layer server 112 generating the blockchain data layer 36, the data records 38 may also carry or reference the single cryptographic address 72. So, should the blockchain data layer 36 create or issue its own cryptocoinage 90, the cryptocoinage 90 may also reference, be identified by, or be associated with the single cryptographic address 72. The single cryptographic address 72 is thus a common indicator or reference data for tracking both the entity's private cryptocoinage 20 and the cryptocoinage 90 issued by the blockchain data layer 36. The transaction records 70 (representing entity's private cryptocoinage 20) may thus be commonly mapped or identified to the cryptocoinage 90 issued by the blockchain data layer 36.

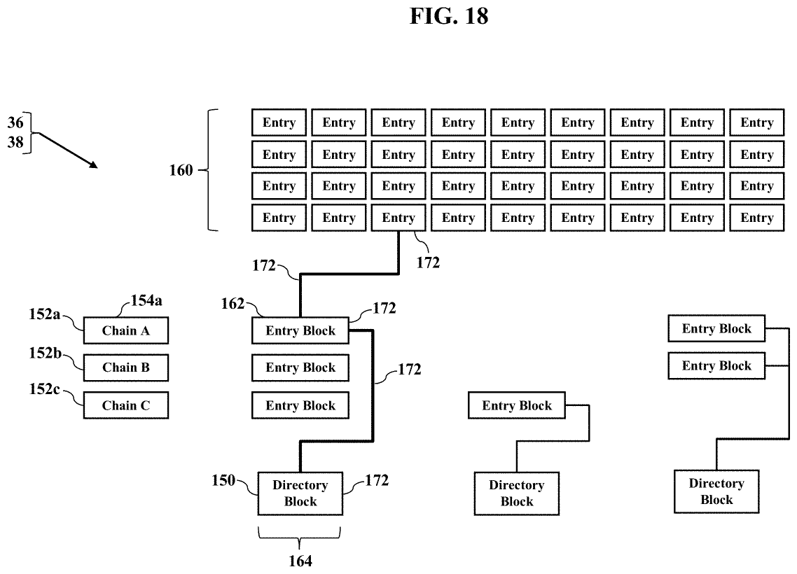

FIG. 18 illustrates a simple illustration. Once the single cryptographic address 72 (and/or its corresponding hash value) is received, the single cryptographic address 72 may propagate and be recorded within the blockchain data layer 36. The single cryptographic address 72, for example, may be recorded in any of the entries 160. The entry 160, and thus the single cryptographic address 72, may then be recorded and/or arranged as the entry block 162 and placed within the directory block 150. The entry 160, the entry block 162, and the directory block 150 may thus reference, specify, or be associated with, the single cryptographic address 72. The single cryptographic address 72 has thus propagated as informational content from the private blockchain 34 and into and through the blockchain data layer 36. The single cryptographic address 72 thus hierarchically moves through the multiple layers of cryptographic hashing for public publication. The blockchain data layer 36 thus tracks the transaction records 70 involving the single cryptographic address 72. In simple words, the blockchain data layer 36 may track ownership and transfer of the entity's private cryptocoinage 20 and the cryptocoinage 90 issued by the blockchain data layer 36, all via the common single cryptographic address 72.

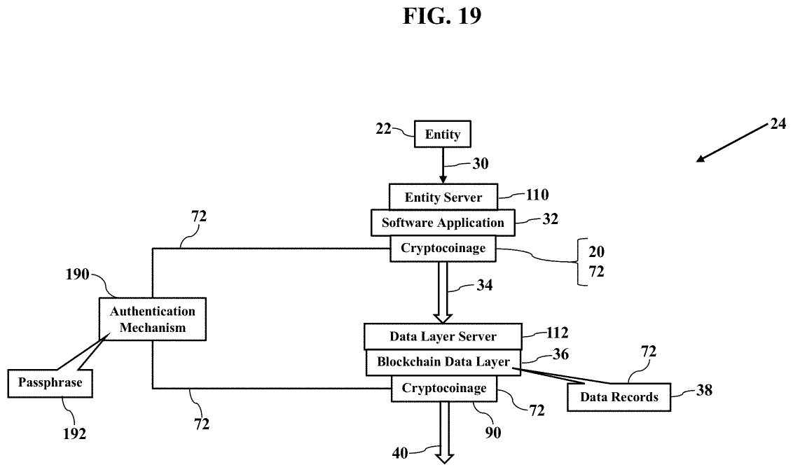

FIG. 19 illustrates more details. While the single cryptographic address 72 may be any alphanumeric entry or biometric input, FIG. 19 illustrates a common authentication mechanism 190. Here the same or similar authentication mechanism 190 is used to access both the entity's private cryptocoinage 20 and the cryptocoinage 90 issued by the blockchain data layer 36. If a user of the blockchain data layer 36 satisfies the authentication mechanism 190, then exemplary embodiments may access both the private cryptocoinage 20 and the cryptocoinage 90. As a simple example, suppose the user of the authentication mechanism 190 supplies information or data representing the single cryptographic address 72. The single cryptographic address 72 may be any unique alphanumeric entry, biometric input, user identifier, or other authentication credential. For example, most readers are likely familiar with an alphanumeric username and password, which is a common authentication mechanism 190. FIG. 19, though, illustrates a passphrase 192 (such as a multi-word mnemonic). When the entity's private cryptocoinage 20 is/are created, generated, or assigned, the entity's private cryptocoinage 20 may be assigned or associated with the passphrase 192. The passphrase 192 is unique to the registered owner, possessor, or user of the entity's private cryptocoinage 20. The passphrase 192 may even be hashed as a hash value and supplied to the blockchain data layer 36 (as above explained). The passphrase 192, in other words, may be hashed as the single cryptographic address 72 and propagated within the blockchain environment 24 to document the transaction records 70 involving the entity's private cryptocoinage 20.

The passphrase 192 may also authenticate to the cryptocoinage 90. If the user correctly supplies the passphrase 192, then the same user may conduct transactions involving the cryptocoinage 90 issued by the blockchain data layer 36. Exemplary embodiments thus allow the user to order transactions and exchanges involving both the entity's private cryptocoinage 20 and the cryptocoinage 90 issued by the blockchain data layer 36.

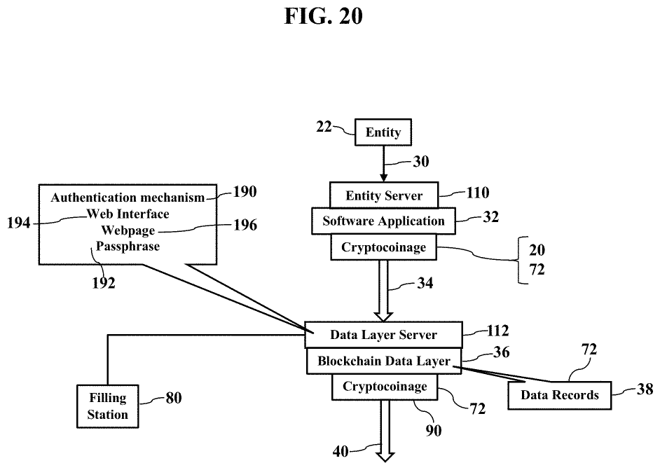

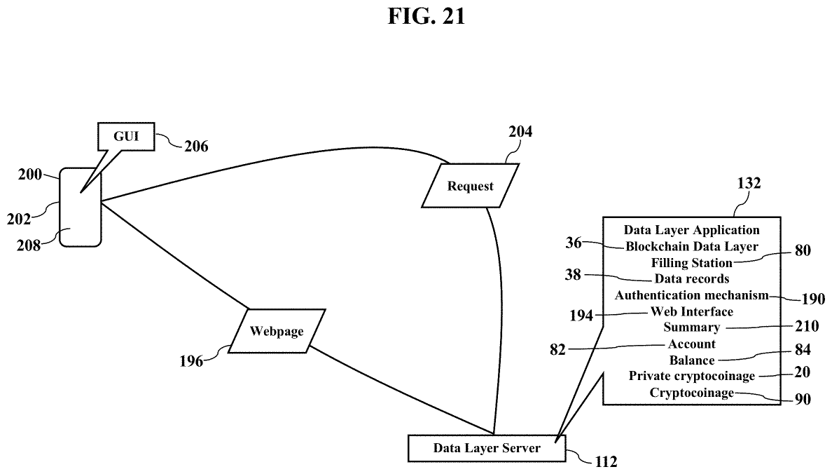

FIGS. 20-22 further illustrate the filling station 80, according to exemplary embodiments. The filling station 80 may be a public and/or private service for financial transactions involving either, or both, of the entity's private cryptocoinage 20 and the cryptocoinage 90 issued by the blockchain data layer 36. FIG. 20 illustrates the filling station 80 as a software-as-a-service offered by the secure data layer server 112 for accessing the blockchain data layer 36. The filling station 80, for example, may be a module within, or called by, the data layer application 132. A user accesses the filling station 80 to conduct transactions involving her private cryptocoinage 20 (issued by the entity 22) and the cryptocoinage 90 (issued by the blockchain data layer 36). While the filling station 80 may have any user interface, FIG. 20 illustrates a web interface 194. That is, the filling station 80 may be accessed via a webpage 196. The webpage 196 prompts the user to input her authentication credentials according to the authentication mechanism 190 (such as typing the passphrase 192 into a data field or audibly speaking the passphrase 192).

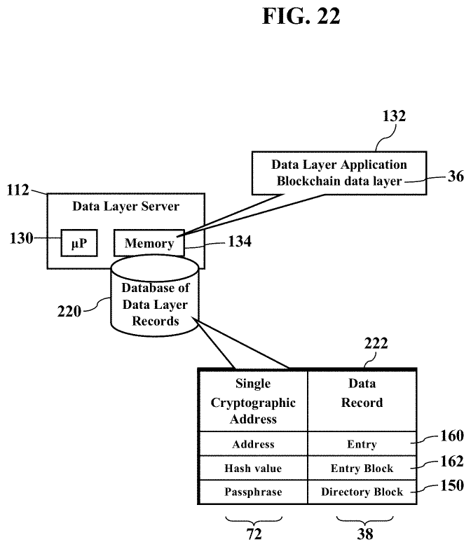

FIG. 22 further illustrates the web interface 194. The user accesses the filling station 80 using a user device 200. While the user device 200 may be any processor-controlled device, most readers are familiar with a smartphone 202. If the smartphone 202 correctly sends authentication credentials (such as the single cryptographic address 72 and/or passphrase 192, as above explained), then the smartphone 202 may utilize the web interface 194 to the data layer server 112 and/or the blockchain data layer 36. The smartphone 202 executes a web browser and/or a mobile application to send a request 204 specifying an address or domain name associated with or representing the filling station 80. The web interface 194 to the data layer server 112 thus sends the webpage 196 as a response, and the user's smartphone 202 downloads the webpage 196. The smartphone 202 has a processor and memory device that executes (not shown for simplicity) that causes a display of the webpage 196 as a graphical user interface (or “GUI”) 206 on its display device 208. The GUI 206 may generate one or more prompts or fields for specifying the authentication mechanism 190 and transactional options. For example, the user preferably enters, speaks, or otherwise provides the passphrase 192. Exemplary embodiments may or may not hash the authentication passphrase (using the hashing algorithm 120 above explained) to produce or generate a hashed passphrase. Exemplary embodiments may then search the blockchain data layer 36 for the data records 38. That is, exemplary embodiments may query the blockchain data layer 36 for a query parameter (such as the single cryptographic address 72, the passphrase 192, and/or their hashed value) and the blockchain data layer 36 identifies the data records 38 that match or reference the query parameter. The filling station 80 may then process the data records 38 to provide a transactional summary 210 of the account 82, the balance 84, and any other transactional data. The filling station 80 may also allow the user to replenish an amount or value of the private cryptocoinage 20 and/or the cryptocoinage 90, even allowing the user to continue exchanging the cryptocoinage 20 for access to the blockchain data layer 36.

Exemplary embodiments may thus share the common authentication mechanism 190. If the entity's private software application 32 requires the same passphrase 192 to buy, sell, or otherwise transact the private cryptocoinage 20, then the passphrase 192 may have been hashed (perhaps as the single cryptographic address 72) and recorded within the blockchain data layer 36. The single cryptographic address 72, in other words, may be associated with the data records 38 representing both the private cryptocoinage 20 (issued by the entity 22) and the cryptocoinage 90 (issued by the blockchain data layer 36). The filling station 80 may thus identify any of the data records 38 that are commonly associated with the single cryptographic address 72, the private cryptocoinage 20 (issued by the entity 22), and/or the cryptocoinage 90. The filling station 80 thus allows the user to exchange cryptocoinage 20 and 90 for access to the private blockchain 34 and/or the blockchain data layer 36.

FIG. 22 illustrates a query mechanism. Here the data layer server 112 may access a database 220 of data layer records. The database 220 of data layer records provides a referential record of the informational content contained within the blockchain data layer 36. FIG. 22 illustrates the data layer server 112 locally storing the database 220 of data layer records in its local memory device 134, but the database 220 of data layer records may be remotely stored and accessed via the communications network 114. Regardless, the data layer server 112 may query the database 220 of data layer records for the single cryptographic address 72 and identify and/or retrieve any corresponding data records 38. While the database 220 of data layer records may have any logical structure, FIG. 22 illustrates the database 220 of data layer records as a table 222 that maps, converts, or translates the single cryptographic address 72 to its corresponding entry 160, entry block 162, and/or directory block 150 within the blockchain data layer 36. Whenever the data layer server 112 generates the entry 160, entry block 162, and/or directory block 150 using the single cryptographic address 72, the data layer server 112 may add an entry to the database 220 of data layer records. Over time, then, the database 220 of data layer tracks a comprehensive historical repository of information that is electronically associated with its corresponding single cryptographic address 72. The data layer server 112 may then read or retrieve the entry 160, entry block 162, and/or directory block 150 containing or corresponding to the single cryptographic address 72.

Exemplary embodiments thus present the entity-specific cryptocoinage 20. Any entity 22 may create its own private blockchain 34 and establish its entity-specific tokens 26. The entity-specific tokens 26 may or may not have the value 64. The tradeable token 52, for example, may have a market value based on supply and/or demand, thus allowing or causing the value 64 of the tradeable token 52 to rise/fall or to increase/decrease, based on market forces. The credit token 50, however, may have a constant price or value, perhaps set by the entity 22. The entity-specific tokens 26 may be associated with the same shared single cryptographic address 72, thus allowing a faster and simpler accounting scheme for each user and/or account 82.

Exemplary embodiments thus create coinage on top of coinage. The hierarchical scheme (explained with reference to FIG. 16) allows the private entity 22 to establish its private cryptocoinage 20 hierarchically above the traditional BITCOIN®, ETHEREUM®, or RIPPLE® coinage. The entity's private data 30 remains private, but the transaction records 70 may be publically documented or proved via the traditional BITCOIN®, ETHEREUM®, or RIPPLE® environment. The private entity 22, in other words, need to worry about or concern itself with public publication. The private entity 22 need only subscribe (e.g., pay for write access) to the blockchain data layer 36.

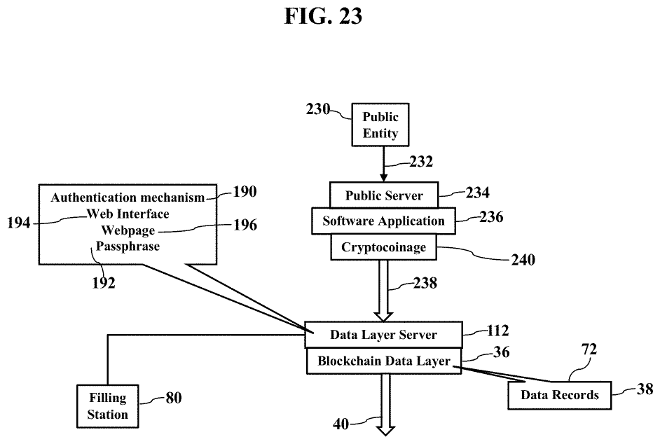

FIG. 23 illustrates a public entity 230, according to exemplary embodiments. Here exemplary embodiments may be applied to public data 232 generated by the public entity 230. The public entity 230 may be a city, state, or federal governmental agency, but the public entity 230 may also be a contractor, non-governmental organization, or other actor that acts on behalf of the governmental agency. The public entity 230 operates a public server 234 and applies its software application 236 to its public data 232 to generate its governmental blockchain 238. The public entity 230 may further generate/issue its cryptocoinage 240. The data layer server 112 receives the governmental blockchain 238 and generates the blockchain data layer 36. The data layer server 112 may then generate the public blockchain 40 representing any data records 38 representing the public data 232 and/or the cryptocoinage 240.

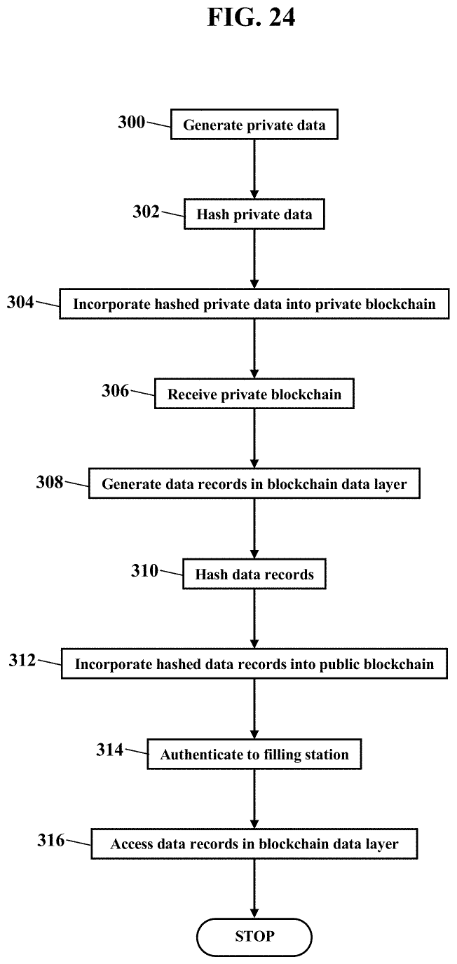

FIG. 24 is a flowchart illustrating a method or algorithm for the private, entity based cryptocoinage 20, according to exemplary embodiments. The electronic private data 30 representing the private cryptocoinage 20 is generated (Block 300), hashed (Block 302), and incorporated into the private blockchain 34 (Block 304). The private blockchain 34 is received by the data layer server 112 (Block 306) and the data records 38 in the blockchain data layer 36 are generated (Block 308). The data records 38 in the blockchain data layer 36 may be hashed (Block 310) and incorporated into the public blockchain 34 (Block 312). When a user successfully authenticates to the filling station 80 (Block 314), the filling station 80 may access the data records 38 in the blockchain data layer 36 (Block 316) representing the private cryptocoinage 20.

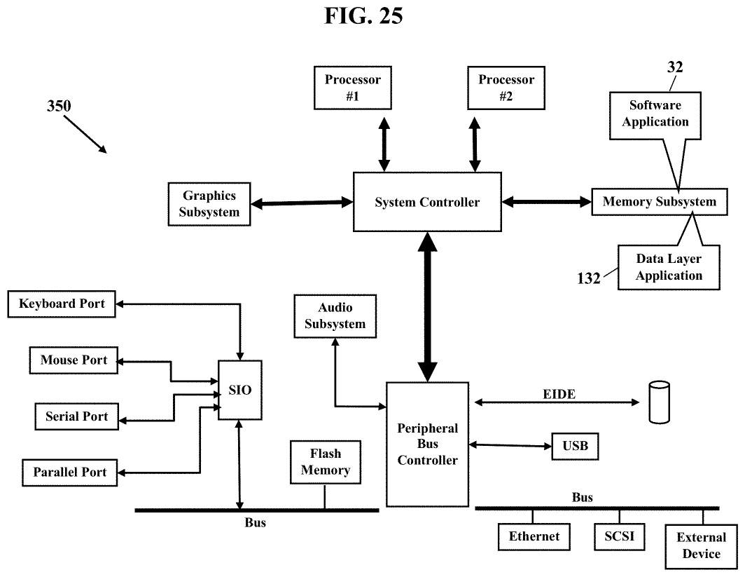

FIG. 25 is a schematic illustrating still more exemplary embodiments. FIG. 25 is a more detailed diagram illustrating a processor-controlled device 350. As earlier paragraphs explained, the entity's private software application 32 and/or the data layer application 132 may partially or entirely operate in any mobile or stationary processor-controlled device. FIG. 25, then, illustrates the entity's private software application 32 and/or the data layer application 132 stored in a memory subsystem of the processor-controlled device 350. One or more processors communicate with the memory subsystem and execute either, some, or all applications. Because the processor-controlled device 350 is well known to those of ordinary skill in the art, no further explanation is needed.

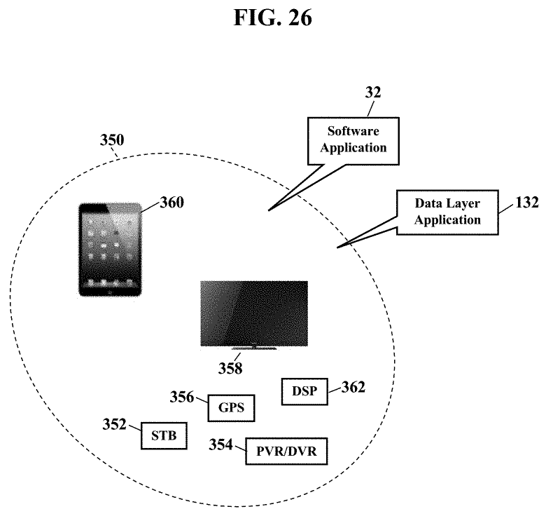

FIG. 26 depicts other possible operating environments for additional aspects of the exemplary embodiments. FIG. 26 illustrates the entity's private software application 32 and/or the data layer application 132 operating within various other processor-controlled devices 350. FIG. 26, for example, illustrates that the entity's private software application 32 and/or the data layer application 132 may entirely or partially operate within a set-top box (“STB”) (352), a personal/digital video recorder (PVR/DVR) 354, a Global Positioning System (GPS) device 356, an interactive television 358, a tablet computer 360, or any computer system, communications device, or processor-controlled device utilizing any of the processors above described and/or a digital signal processor (DP/DSP) 362. Moreover, the processor-controlled device 350 may also include wearable devices (such as watches), radios, vehicle electronics, clocks, printers, gateways, mobile/implantable medical devices, and other apparatuses and systems. Because the architecture and operating principles of the various devices 350 are well known, the hardware and software componentry of the various devices 350 are not further shown and described.

Exemplary embodiments may be applied to any signaling standard. Most readers are thought familiar with the Global System for Mobile (GSM) communications signaling standard. Those of ordinary skill in the art, however, also recognize that exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard. Exemplary embodiments may also be applied to other standards, such as the I.E.E.E. 802 family of standards, the Industrial, Scientific, and Medical band of the electromagnetic spectrum, BLUETOOTH®, and any other.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for establishing the entity-specific private cryptocoinage 20, as the above paragraphs explain.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method, comprising:
receiving, by a server, a private blockchain associated with a private entity, the private blockchain containing cryptographically hashed private data associated with private cryptocoinage issued by the private entity;
generating, by the server, a blockchain data layer based on the cryptographically hashed private data associated with the private cryptocoinage issued by the private entity;
generating, by the server, a cryptographic proof based on a hashing of the blockchain data layer; and
publically publishing, by the server, the cryptographic proof via a public blockchain;
wherein the public blockchain publically publishes the cryptographic proof associated with the private cryptocoinage issued by the private entity.

2. The method of claim 1, further comprising receiving a block of data in the private blockchain that is associated with the private cryptocoinage.

3. The method of claim 1, further comprising receiving a single cryptographic address that is associated with the private cryptocoinage.

4. The method of claim 1, further comprising determining a single cryptographic address that is associated with a credit token of the private cryptocoinage.

5. The method of claim 1, further comprising determining a single cryptographic address that is associated with a tradeable token of the private cryptocoinage.

6. The method of claim 1, further comprising determining a single cryptographic address that is associated with both a credit token and a tradeable token of the private cryptocoinage.

7. The method of claim 1, further comprising anchoring the cryptographic proof to another public blockchain, the another public blockchain associated with a different cryptocoinage.

8. A system, comprising:
a hardware processor; and
a memory device, the memory device storing instructions, the instructions when executed causing the hardware processor to perform operations, the operations comprising:
receiving a private blockchain associated with a private entity, the private blockchain containing cryptographically hashed private data associated with private cryptocoinage issued by the private entity;
generating a blockchain data layer based on the cryptographically hashed private data associated with the private cryptocoinage issued by the private entity;
generating a cryptographic proof based on a hashing of the blockchain data layer;
publically publishing the cryptographic proof via a public blockchain;
querying the blockchain data layer for a single cryptographic address; and
identifying transaction records in the blockchain data layer that are associated with the single cryptographic address, the transaction records representing a credit token and a tradeable token of the private cryptocoinage issued by the private entity;
wherein the public blockchain publically publishes the cryptographic proof associated with the transaction records representing the private cryptocoinage issued by the private entity.

9. The system of claim 8, wherein the operations further comprise receiving a request for a webpage, the request for the webpage specifying the single cryptographic address.

10. The system of claim 8, wherein the operations further comprise receiving a block of data in the private blockchain that is associated with the private cryptocoinage.

11. The system of claim 8, wherein the operations further comprise receiving the single cryptographic address in the private blockchain.

12. The system of claim 8, wherein the operations further comprise receiving a textual passphrase.

13. The system of claim 12, wherein the operations further comprise performing a hash of the textual passphrase to generate a hashed passphrase.

14. The system of claim 8, wherein the operations further comprise anchoring the cryptographic proof to another public blockchain, the another public blockchain associated with a different cryptocoinage.

15. A memory device storing instructions that when executed cause a hardware processor to perform operations, the operations comprising:
receiving a private blockchain associated with a private entity, the private blockchain containing cryptographically hashed private data associated with private cryptocoinage issued by the private entity and associated with a single cryptographic address;
generating a blockchain data layer based on the cryptographically hashed private data associated with the private cryptocoinage issued by the private entity;
generating a cryptographic proof based on a hashing of the blockchain data layer;
publically publishing the cryptographic proof via a public blockchain;
issuing a cryptocoinage for accessing the blockchain data layer;
associating the cryptocoinage for the accessing of the blockchain data layer to the single cryptographic address;
querying the blockchain data layer for the single cryptographic address; and
identifying data records in the blockchain data layer that are associated with the single cryptographic address, the data records electronically associating the single cryptographic address to a private credit token and to a private tradeable token of the private cryptocoinage issued by the private entity;
wherein the public blockchain publically publishes the cryptographic proof associated with the data records representing the private cryptocoinage issued by the private entity.

16. The memory device of claim 15, wherein the operations further comprise receiving a request for a webpage, the request for the webpage specifying the single cryptographic address.

17. The memory device of claim 15, wherein the operations further comprise receiving a block of data in the private blockchain that is associated with the private cryptocoinage.

18. The memory device of claim 15, wherein the operations further comprise receiving the single cryptographic address in the private blockchain.

19. The memory device of claim 15, wherein the operations further comprise receiving a textual passphrase.

20. The memory device of claim 15, wherein the operations further comprise anchoring the cryptographic proof to another public blockchain, the another public blockchain associated with a different cryptocoinage.
